(19) United States
(12) Patent Application Publication
(10) Pub. No.: US 2016/0338548 A1
(43) Pub. Date: Nov. 24, 2016

(54) TWO-SIDED, REVERSIBLE, SELF-DRAINING CUTTING/CARVING BOARD

(71) Applicant: Joshua Kelly Manahan, Sutton, MA (US)

(72) Inventor: Joshua Kelly Manahan, Sutton, MA (US)

(21) Appl. No.: 15/162,350

(22) Filed: May 23, 2016

Related U.S. Application Data
(60) Provisional application No. 62/165,912, filed on May 23, 2015.

(51) Int. Cl. A47J 47/00

(52) U.S. Cl. CPC A47J 47/005

(57) ABSTRACT

A work surface for cutting or carving food which is elevated off a counter top allowing room underneath to collect any liquids generated. The surface is gently sloped away from the edges leading to a hole in the interior of the board through which liquids are neatly collected in a container (not part of the invention) beneath the board. The subtly curved surface does not impede the use of the board for chopping purposes. The elevated surface also allows a container to be placed beside the board into which chopped food can quickly and conveniently be swept off the surface.

### CROSS-REFERENCE TO RELATED APPLICATIONS

This application claims the benefit under 35 U.S.C. section 119(e) of U.S. Provisional patent application No. 62165912 filed May 23, 2015, all of which is hereby incorporated by reference.

### THE FIELD OF THE INVENTION

This invention involves the construction of a cutting/carving board using current machining techniques and magnet technology to make a convenient elegant cutting board.

### STATEMENT REGARDING FEDERALLY SPONSORED RESEARCH OR DEVELOPMENT

This invention has been created without the sponsorship or funding of any federally sponsored research or development program.

### REFERENCE TO SEQUENCE LISTING, A TABLE, OR A COMPUTER PROGRAM LISTING COMPACT DISK APPENDIX

Not applicable.

### BACKGROUND OF THE INVENTION

Cutting/carving boards, particularly when used for carving meat, have typically been inconvenient and awkward to use because of the meat juice generated while carving. They usually collect juices in grooves and/or reservoirs of limited capacity and the user must remove the meat and then carefully lift and tilt the board to empty the juice for further processing or disposal. When typical boards are used for chopping food the same grooves or reservoirs prevent easy removal of the chopped products for serving or further processing.

Several designs have been patented providing improved juice collection notably U.S. Pat. No. 3,598,164 to August. These solutions, however, make it necessary for the user to cope with grooves and/or board edges making it difficult to remove product, either chopped or carved from the surface of the board. Because the surfaces have edges and grooves they are hard to clean.

This invention elegantly improves juice collection and makes removing product after chopping or carving very easy. Because of its smooth surface it is very easy to clean. The top surface of this board uses subtle curves to guide liquids to a container that is independent of the board and is easily slid from under the board so the liquids can be processed further. Further, the legs supporting the board in its preferred embodiment are attached with magnets and are immediately removable, leaving the bottom of the board completely flat, easy to clean, so it can be used to chop and carve as well as the top side.

Many cutting boards are flat with grooves and/or reservoirs to capture liquids when used for carving products that generate liquids. To process the liquids further the user must lift the board and carefully tilt it over some receptacle to empty the juice and then clean the grooved surface of greasy remnants. Attempts to alleviate these shortcomings have been made, but by and large people still struggle with collecting meat juices and when dealing with chopped foods it is necessary to pick them out of these grooves to process them further.

The present invention simply and elegantly provides an improved method of collecting liquids generated during a meat carving process, and its subtly carved surface also improves the method of chopping and transferring vegetables on the same surface.

### BRIEF SUMMARY OF THE INVENTION

The invention can be fabricated of wood, plastic, or other appropriate material. The top surface of the board is contoured so that any place on the board will lead liquid toward a hole through which it will drain into a container placed below the board. The space below the board is created by legs which raise the board above a counter. In the preferred embodiment of the invention, the legs are attached to the board with magnets which leave the bottom of the board flat except for the drain hole and a drip edge. An important aspect of using this invention, is a container, more specifically a tray-like container which is not part of the invention but is used to collect liquids and/or chopped food by being place under or along side the board. It can be any container that fits under the board, a tray is shown in dashed lines in the drawings to illustrate its use.

### DESCRIPTION OF THE DRAWINGS

Throughout the drawings the same number is always used to identify an entity.

FIG. 1 is a perspective drawing showing the preferred embodiment with section marks to indicate the source of the section drawings.

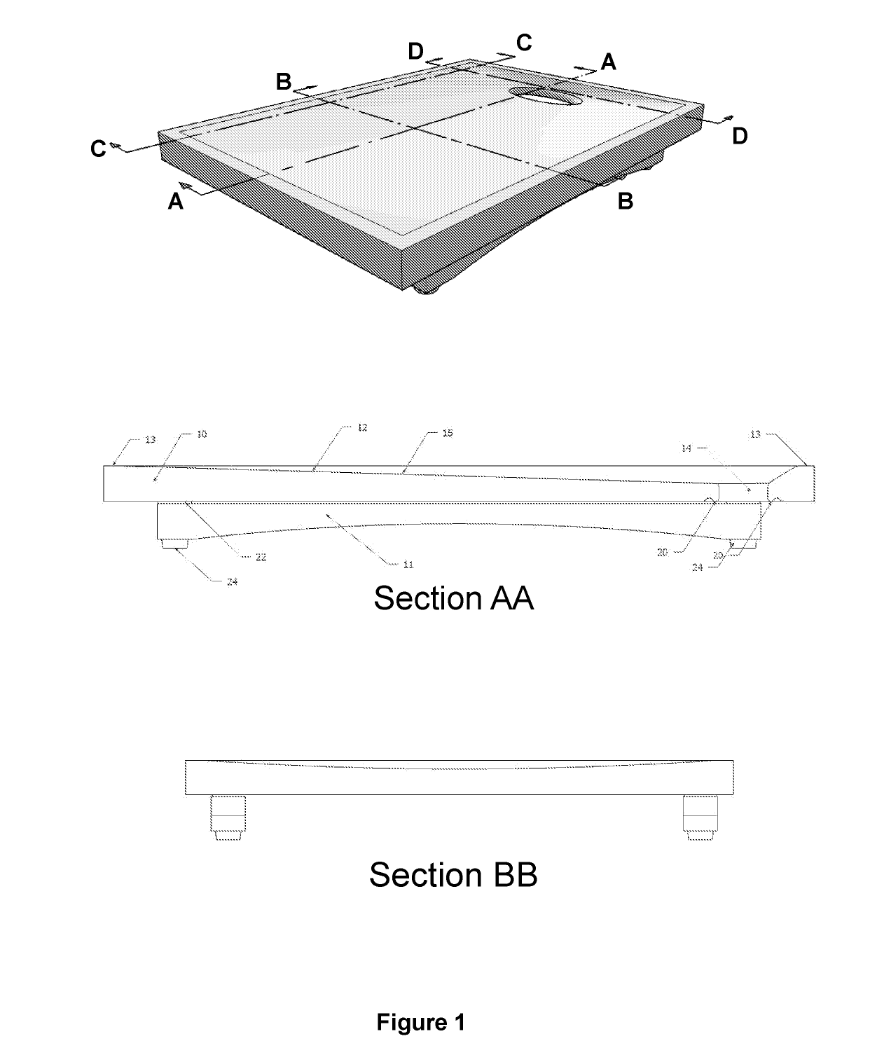

FIG. 2 shows a leg and the components that make it up and section marks to indicate the source of the section views.

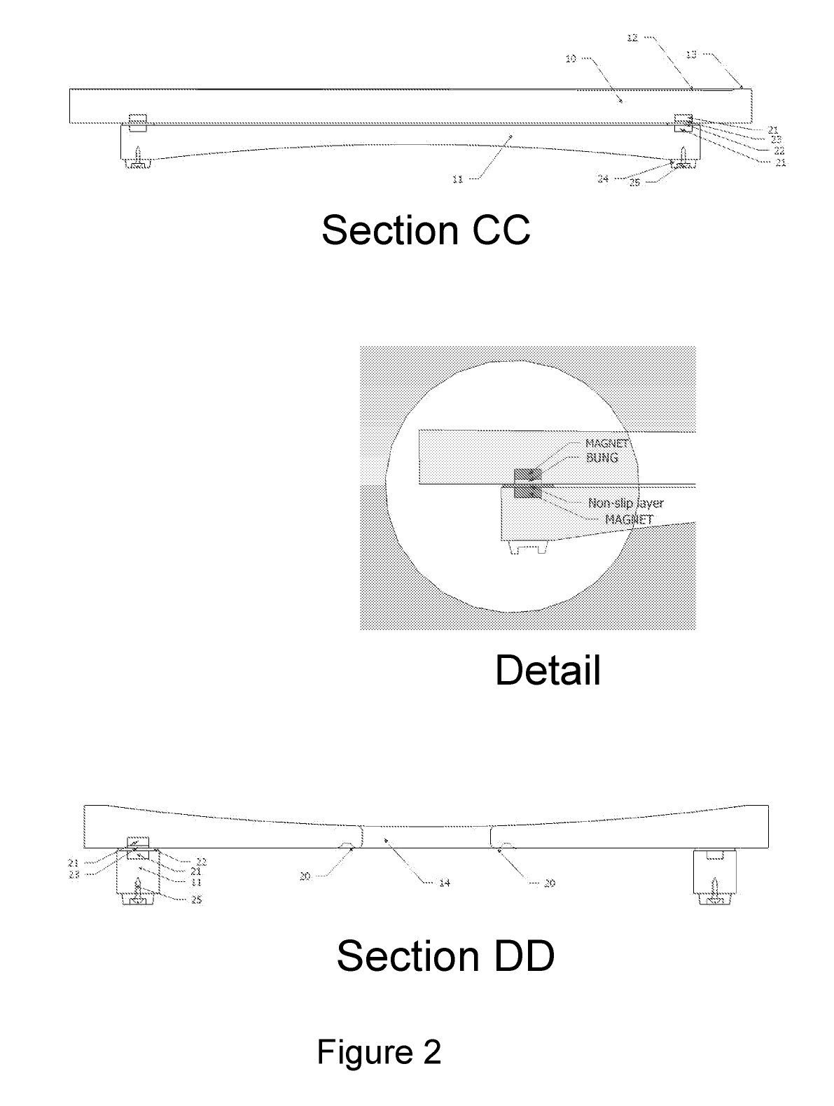

### DETAILED DESCRIPTION OF THE INVENTION

This invention is comprised of a cutting board 10 (herein referred to as “board”) and two identical legs 11. The term board as used here is not meant to be limited to wood but refers to any suitable material for the purpose. The board and legs can be fabricated from wood, food-grade plastic or other suitable material. In the preferred embodiment the board is attached to the legs using embedded magnets 21. This description will detail the board and then the legs.

The essence of the invention is the smooth top surface 12 of the board which is contoured in such a way that the entire surface, with the exception of the narrow margin 13 at its edge, leads liquids toward a hole 14 close to one end of the board. Section drawing A-A shows the gentle slope 15 which leads liquid from the flat end of the board 16 to the hole end 17. In a similar fashion, Section drawing B-B shows typical slopes 18 which guide liquid from the sides of the board toward the hole where it is drained off the surface of the board. The hole can be any shape but the preferred embodiment of the invention uses an ellipse of such size that a few fingers fit through making is easy to transport the board. The narrow margin 13 along all edges of the board is at the same elevation so when the board is turned over and the legs are removed it sits perfectly flat exposing the bottom of the board 19 which is flat except for the hole 14 and a drip edge 20.

Section drawing C-C is drawn through the board and leg at the center of the leg. It shows where magnets 21 are embedded in both the board and the leg and the layer above the magnet which provides a non-slip surface 22 between the board and leg when the leg is attached. It also shows bungs 23, fabricated of the same material as the board, placed in the board to cover the magnets and provide a smooth flat cutting surface on the bottom side of the board. It also shows feet 24 and their fastening screw 25 which provide non-slip stability to the board.

1. A cutting/carving board comprised of a carved block made of wood or plastic with a hole through it, and apparatus to support said board above a counter, the carved surface of said board is gently sloped downward from the outside edges toward the said hole in the interior of the board.

2. The invention of claim 1 wherein the apparatus supporting said board is attached to said board by magnets strategically embedded in the board and/or in the supporting apparatus, thus making the said apparatus stable and easily removed enabling reversibility of the board.

3. The invention of claim 1 wherein the apparatus supporting said board is permanently attached to said board without magnets.

4. The invention recited in claim 2 whereby the said apparatus is comprised of two legs each having two feet to support two corners of said board; further the said feet are comprised of a material providing a non-slip relation between said feet and a surface and are appropriately attached to said leg; further each of said legs are also comprised of a layer of material to lie between the leg and the board at the point above the magnet embedded in the leg, and said layer provides friction between the board and the leg to reduce lateral movement and for stability.

5. The invention recited in claim 4 having magnets embedded in each leg just below the material layered between the leg and the board; further the board is comprised of magnets embedded a predetermined distance above the surface of the bottom of the board and covered by a bung of predetermined thickness.
